(19) United States
(12) Patent Application Publication
(10) Pub. No.: US 2008/0116813 A1
(43) Pub. Date: May 22, 2008

(54) Plasma display device and switching mode power supply

(76) Inventor: Young-Oh Choi, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/975,036

(22) Filed: Oct. 16, 2007

(30) Foreign Application Priority Data
Nov. 20, 2006 (KR) 10-2006-0114542

(51) Int. Cl. G09G 3/10

(52) U.S. Cl. 315/169.4

(57) ABSTRACT

A plasma display device and a switching mode power supply for a driving circuit of the plasma display device. The power supply includes a plurality of transformers arranged to generate a plurality of supply voltages which have reduced cross regulation are disclosed.

### CROSS-REFERENCE TO RELATED APPLICATION

This application claims priority to and the benefit of Korean Patent Application No. 10-2006-0114542 filed in the Korean Intellectual Property Office on Nov. 20, 2006, the entire content of which is incorporated herein by reference.

### BACKGROUND

1. Field of the Invention

The field relates to a plasma display device and a switching mode power supply.

2. Description of the Related Technology

A plasma display device is a device that displays characters or images using plasma generated by gas discharge. Depending on its size, the plasma display panel (PDP) may include more than from several scores to millions of discharge cells arranged in a matrix.

In general, the plasma display device is driven by dividing each frame into a plurality of subfields each having a weighted value. Grayscales of a particular discharge cell in the PDP may be expressed as a combination of the weighted values of the subfields during a display operation. During an address period of each subfield, turn-on cells and turn-off cells are selected. Then, during a sustain period, in order to actually display an image, the turn-on cells perform sustain discharge.

A plasma display device often includes two voltage supplies, and generates other voltages having different levels using the two voltage supplies and a number of voltage-generators. The other voltages include a voltage (address voltage) that is supplied to the turn-on cells during the address period voltage and a voltage (sustain voltage) that is supplied to the cells performing sustain discharge during the sustain period. The voltage generators may prevent the reduction in the number of parts and an increase integration beyond a desired level. In order to solve this problem, an integrated voltage supply that supplies two or more voltages using a single voltage generator is suggested.

However, in the known integrated voltage supply, cross regulation occurs, which causes degradation of output characteristics of the sustain voltage.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display device including a plurality of first electrodes, a driving circuit unit configured to drive the first electrodes, and a power supply configured to generate a power supply voltage for the driving circuit unit, where the power supply includes a power supply unit including a switching transistor coupled to a primary side first coil of a first transformer configured to transform an input voltage, and to supply power to a secondary side second coil of the first transformer according to an operation of the switching transistor. The power supply also includes a first output unit configured to output a first voltage generated in the secondary side second coil of the first transformer, and a second output unit including a third coil coupled in parallel to the second coil and a fourth coil cooperatively forming a second transformer with the third coil, where the second output unit is configured to output a second voltage induced from the third coil and generated in the fourth coil.

Another aspect is a switching mode power supply including a power supply unit including a switching transistor coupled to a primary side first coil of a first transformer configured to transform an input voltage, where the power supply unit is configured to supply power to a secondary side second coil of the first transformer according to an operation of the switching transistor. The power supply also includes a first output unit configured to output a first voltage generated in the secondary side second coil of the first transformer, and a second output unit including a third coil coupled in parallel to the second coil and a fourth coil forming a second transformer together with the third coil, the second output unit configured to output a second voltage induced from the third coil and generated in the fourth coil.

Another aspect is a plasma display device including a plurality of first electrodes, a driving circuit unit configured to drive the first electrodes, and a power supply configured to generate a power supply voltage for the driving circuit unit, where the power supply includes a first transformer configured to generate a first output voltage based at least in part on an input voltage, and a second transformer configured to generate a second output voltage based at least in part on the first output voltage.

### BRIEF DESCRIPTION OF THE DRAWINGS

FIG. 1 is a block diagram showing a plasma display device according to one embodiment.

FIG. 2 is a diagram showing a switching mode power supply according to one embodiment.

### DETAILED DESCRIPTION OF CERTAIN INVENTIVE EMBODIMENTS

Some embodiments provide a plasma display device and a switching mode power supply, having advantages of stably supplying a plurality of voltages without suffering from cross regulation.

In the following detailed description, certain embodiments are shown and described, simply by way of illustration. As those skilled in the art would realize, the described embodiments may be modified in various ways, without departing from the spirit or scope of the present invention.

Throughout this specification and the claims that follow, when it is described that an element is coupled to another element, the element may be directly coupled to the other element or electrically coupled to the other element through a third element.

A plasma display device and a switching mode power supply according to certain embodiments will now be described with reference to the drawings.

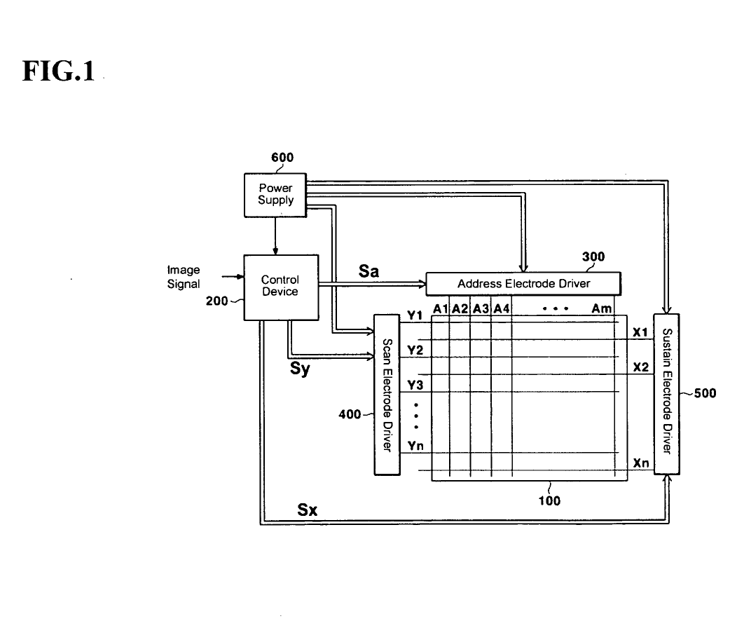

FIG. 1 is a block diagram showing a plasma display device according to an embodiment.

As shown in FIG. 1, a plasma display device can include a plasma display panel (PDP) 100, a control device 200, an address electrode driver 300, a scan electrode driver 400, a sustain electrode driver 500, and a power supply 600.

The plasma display panel (PDP) 100 is provided with a plurality of address electrodes A1 to Am extending in a column direction, and a plurality of sustain electrodes X1 to Xn and scan electrodes Y1 to Yn extending in a row direction in pairs. The sustain electrodes X1 to Xn are formed to correspond to the scan electrodes Y1 to Yn. In some embodiments, one end of the sustain electrodes X1 and Xn are connected to one another. The plasma display panel (PDP) 100 has a substrate (not shown) on which the sustain electrodes X1 to Xn and the scan electrodes Y1 to Yn are arranged and a substrate (not shown) on which the address electrodes A1 to Am are arranged. The two substrates are disposed to face each other with a discharge space interposed therebetween such that the scan electrodes Y1 to Yn and the address electrodes A1 to Am, and the sustain electrodes X1 to Xn and the address electrodes A1 to Am are perpendicular to each other. Discharge spaces near intersections of the address electrodes A1 to Am, the sustain electrodes X1 to Xn, and the scan electrodes Y1 to Yn form discharge cells. The above-described structure of the plasma display panel (PDP) 100 is an example. Other configurations may be used.

The control device 200 receives a video signal from the outside and outputs an address electrode driving control signal Sa, a sustain electrode driving control signal Sx, and a scan electrode driving control signal Sy. The control device 200 performs driving by dividing each frame into a plurality of subfields. Each subfield includes a reset period, an address period, and a sustain period. Further, the control device 200 generates a high scan voltage Vscan_h, which is applied to cells to be not addressed in the address period, using a DC voltage supplied from the power supply 600 and supplies the generated high scan voltage to at least one of the scan electrode driver 400 and the sustain electrode driver 500.

The address electrode driver 300 receives the address electrode driving control signal Sa from the control device 200 and applies display data signals for selecting the discharge cells to the individual address electrodes.

The scan electrode driver 400 receives the scan electrode driving control signal Sy from the control device 200 and applies a driving voltage to the scan electrodes Y. The sustain electrode driver 500 receives the sustain electrode driving control signal Sx from the control device 200 and applies a driving voltage to the sustain electrodes X.

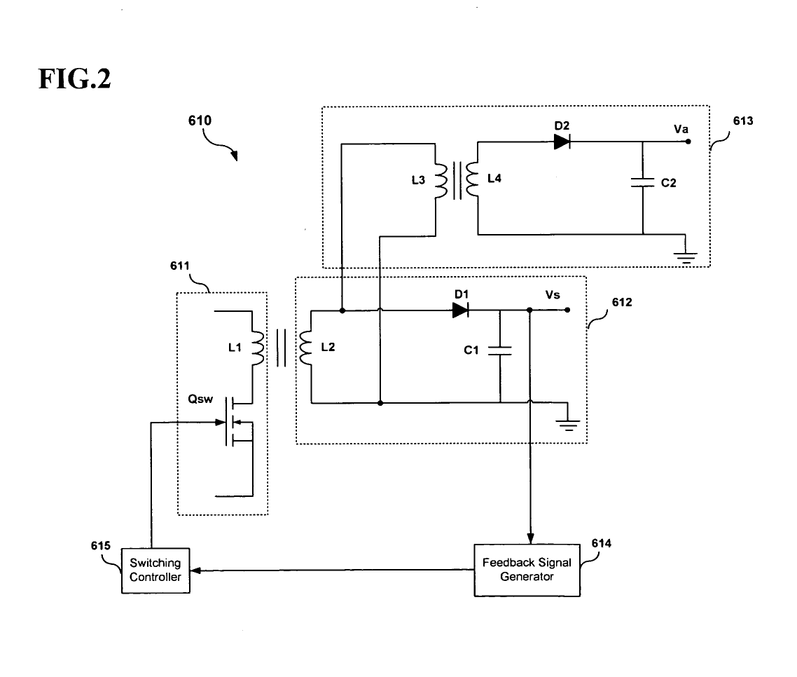

The power supply 600 supplies voltages required for driving the plasma display device to the control device 200 and the individual drivers 300, 400, and 500. A switching mode power supply that is included in the power supply 600 and generates an address voltage and a sustain voltage will be described with reference to FIG. 2.

FIG. 2 is a diagram showing a switching mode power supply according to an embodiment.

As shown in FIG. 2, the switching mode power supply 610 according to one embodiment includes a power supply unit 611, a sustain voltage generator 612, an address voltage generator 613, a feedback signal generator 614, and a switching controller 615.

The power supply unit 611 includes a primary coil L1 of a transformer and a switching transistor Qsw connected to the primary coil L1. The power supply unit 611 transforms an input voltage through the transformer, and supplies power to a secondary side of the transformer, that is, the sustain voltage generator 612 and the address voltage generator 613, according to a duty of the switching transistor Qsw.

The sustain voltage generator 612 includes a secondary coil L2 of the transformer, one end of which is connected to a ground terminal, a diode D1, an anode of which is connected to the other end of the secondary coil L2 and a cathode of which is connected to a sustain voltage output terminal, and a capacitor C1, one end of which is connected to the cathode of the diode D1 and the other end of which is connected to one end of the secondary coil L2.

The address voltage generator 613 includes a third coil L3, one end of which is connected to one other end of the secondary coil L2 of the transformer and the other end of which is connected to the other end of the secondary coil L2, a fourth coil L4 that forms a transformer with the third coil L3 and one end of which is connected to the ground terminal, a diode D2, an anode of which is connected to the other end of the fourth coil L4 and a cathode of which is connected to an address voltage output terminal, and a capacitor C2, one end of which is connected to the cathode of the diode D2 and the other end of which is connected to one end of the fourth coil L4.

The feedback signal generator 614 is connected to an output terminal of the sustain voltage generator 612. The feedback signal generator 614 receives an output voltage output from the sustain voltage generator 612 and generates a feedback signal. The switching controller 615 receives the feedback signal generated by the feedback signal generator 614 and controls turn-on/off of the switching transistor Qsw in the power supply unit 611. Accordingly, the output voltages of the sustain voltage generator 612 and the address voltage generator 613 can be accurately controlled.

Driving of the switching mode power supply 610 will be described in detail.

First, power induced from the primary coil L1 of the transformer in the power supply unit 611 to the secondary coil L1 in the sustain voltage generator 612 may be constant.

If the load of the output terminal of the address voltage generator 613 decreases, the amount of current flowing to the address voltage output terminal through the diode D2 increases. Therefore, a voltage between both ends of the third coil L3 decreases. Because the secondary coil L2 and the third coil L3 are coupled in parallel, the decrease in voltage applied to the third coil L3 is accompanied by a decrease in voltage between both ends of the secondary coil L2. For this reason, a voltage of the sustain voltage output terminal also decreases. Also, if the load of the output terminal of the address voltage generator 613 increases, the amount of current flowing to the address voltage output terminal through the diode D2 decreases. Then, the voltage between both ends of the third coil L3 increases. Therefore, a voltage between both ends of the secondary coil L2 that is connected in parallel to the third coil L3 increases.

That is, a change in output voltage of the address voltage generator 613 is reflected in a change in output voltage of the sustain voltage generator 612 as it is. For this reason, the feedback signal generator 614 generates the feedback signal corresponding to the change in output voltage of the address voltage generator 613. The switching controller 615 controls turn-on/off of the switching transistor Qsw according to the feedback signal corresponding to the change in output voltage of the address voltage generator 613.

According to the above-described switching mode power supply 610, the sustain voltage and the address voltage can be stably supplied using a single switching mode power supply, without causing cross regulation. As a result, the area and costs for implementing the plasma display device can be reduced.

Further, the switching mode power supply 610 can be used to generate other voltages to be generated in the power supply 600 (see FIG. 1) for driving the plasma display device, in addition to the sustain voltage and the address voltage.

The switching mode power supply 610 can be used in other display devices or other power supplies, in addition to the plasma display device.

As described above, according to the exemplary embodiment of the present invention, the sustain voltage and the address voltage can be stably supplied using a single switching mode power supply, without causing cross regulation. As a result, the area and costs for implementing a plasma display device can be reduced.

While this invention has been described in connection with what is presently considered to be practical embodiments, it is to be understood that the invention is not limited to the disclosed embodiments, but, on the contrary, is intended to cover various modifications and arrangements.

What is claimed is:

1. A plasma display device comprising:
a plurality of first electrodes;
a driving circuit unit configured to drive the first electrodes; and
a power supply configured to generate a power supply voltage for the driving circuit unit, wherein the power supply comprises:
a power supply unit comprising a switching transistor coupled to a primary side first coil of a first transformer configured to transform an input voltage, and to supply power to a secondary side second coil of the first transformer according to an operation of the switching transistor;
a first output unit configured to output a first voltage generated in the secondary side second coil of the first transformer, and
a second output unit comprising:
a third coil coupled in parallel to the second coil; and
a fourth coil cooperatively forming a second transformer with the third coil,
wherein the second output unit is configured to output a second voltage induced from the third coil and generated in the fourth coil.

2. The plasma display device of claim 1, wherein the power supply further includes:
a feedback signal generator configured to receive the first voltage and to generate a feedback signal; and
a switching controller that controls turn-on/off of the switching transistor according to the feedback signal.

3. The plasma display device of claim 1, wherein the first voltage is a higher voltage of voltages to be alternately supplied to the first electrodes during a sustain period.

4. The plasma display device of claim 1, wherein the second voltage is an address data voltage to be sequentially applied to the plurality of first electrodes during an address period.

5. A switching mode power supply comprising:
a power supply unit comprising a switching transistor coupled to a primary side first coil of a first transformer configured to transform an input voltage, the power supply unit configured to supply power to a secondary side second coil of the first transformer according to an operation of the switching transistor;
a first output unit configured to output a first voltage generated in the secondary side second coil of the first transformer; and
a second output unit comprising a third coil coupled in parallel to the second coil and a fourth coil forming a second transformer together with the third coil, the second output unit configured to output a second voltage induced from the third coil and generated in the fourth coil.

6. The switching mode power supply of claim 5, further comprising:
a feedback signal generator configured to receive the first voltage and to generate a feedback signal; and
a switching controller that controls turn-on/off of the switching transistor according to the feedback signal.

7. The switching mode power supply of claim 5, wherein the first output unit includes:
the second coil, connected to a first power source configured to supply a third voltage;
a first diode, comprising:
a cathode connected to the second coil; and
an anode connected to an output terminal; and
a first capacitor, connected to the anode of the first diode and to the second coil.

8. The switching mode power supply of claim 7, wherein the second output unit includes:
the third coil, connected to the second coil and to the second coil;
the fourth coil, connected to a second power source supplying a fourth voltage;
a second diode comprising:
a cathode connected to the fourth coil; and
an anode connected to an output terminal; and
a second capacitor, connected to the anode of the second diode and connected to the fourth coil.

9. The switching mode power supply of claim 8, wherein the third and fourth voltages are a ground voltage.

10. A plasma display device comprising:
a plurality of first electrodes;
a driving circuit unit configured to drive the first electrodes; and
a power supply configured to generate a power supply voltage for the driving circuit unit, wherein the power supply comprises:
a first transformer configured to generate a first output voltage based at least in part on an input voltage; and
a second transformer configured to generate a second output voltage based at least in part on the first output voltage.

11. The plasma display device of claim 10, wherein the power supply further comprises a diode and a capacitor cooperatively configured to generate a first power supply voltage for the driving circuit unit based at least in part on the first output voltage.

12. The plasma display device of claim 11, wherein the power supply further comprises another diode and another capacitor cooperatively configured to generate a second power supply voltage for the driving circuit unit based at least in part on the second output voltage.

13. The plasma display device of claim 10, wherein the power supply further comprises a feedback signal generator configured to generate a feedback signal based at least in part on the first output voltage, wherein the first transformer is configured to operate based at least in part on the feedback signal.

14. The plasma display device of claim 13, wherein the feedback signal generator is further configured to generate the feedback signal based at least in part on the second output voltage.

15. The plasma display device of claim 10, wherein the power supply further comprises a switching transistor configured to control the operation of the first transformer based at least in part on the feedback signal.

16. The plasma display device of claim 15, wherein the power supply further comprises a feedback signal generator configured to generate a feedback signal based at least in part on the first output voltage, wherein the switching transistor is configured to control the operation of the first transformer based at least in part on the feedback signal.

17. The plasma display device of claim 10, wherein the power supply is configured to generate a first power supply voltage for the driving circuit unit based at least in part on the first output voltage, and to provide the first power supply voltage to the first electrodes during a sustain period.

18. The plasma display device of claim 17, wherein the power supply comprises a diode and a capacitor configured to generate the first power supply voltage based at least in part on the first output voltage.

19. The plasma display device of claim 10, wherein the power supply is configured to generate a second power supply voltage for the driving circuit unit based at least in part on the second output voltage, and to provide the second power supply voltage to the first electrodes during an address period.

20. The plasma display device of claim 19, wherein the power supply comprises a diode and a capacitor configured to generate the second power supply voltage based at least in part on the second output voltage.
